(19) United States
(12) Patent Application Publication
(10) Pub. No.: US 2011/0306721 A1
(43) Pub. Date: Dec. 15, 2011

(54) Flame retardant material having enhanced pull through lubricity

(76) Inventors: Veerag Mehta, South Plainfield, NJ (US); David Romenesko, Midland, MI (US); Anand Mishra, Mount Laurel, NJ (US)

(21) Appl. No.: 13/134,100

(22) Filed: May 27, 2011

Related U.S. Application Data
(60) Provisional application No. 61/397,333, filed on Jun. 10, 2010.

(51) Int. Cl. C08L 83/00; C09K 21/14

(52) U.S. Cl. 524/588

(57) ABSTRACT

A process for preparing fire retardant materials having enhanced lubricity, wherein the process comprises providing a silicone, curable, fire retardant material and partially curing the curable fire retardant material to a semi-fluid, gum-like gel prior to any end use application.

This application claims priority from U.S. provisional patent application having Ser. No. 61/397,333, filed on Jun. 10, 2010.

The present invention deals with a process for providing flame retardant materials having enhanced pull through lubricity and the materials produced thereby. For purposes of this invention, “fire retardancy” and “flame retardancy” are considered equivalent.

### BACKGROUND OF THE INVENTION

Plastic materials utilized in today's engineering world have greatly increased in demand. These materials have been used in such applications as various components for automobiles, machines, home and office furniture, airplane components and the like.

In recent years, engineers have turned their attention to fire retardancy of these plastics and various systems, and schemes have been proposed for providing fire retardancy within certain cost parameters.

A major use of such materials is in the manufacturing of coated wires in which flame retardancy plays a major role. In the coated wire manufacturing process, there is a requirement that the materials have lubricity so that the wires that are coated can be produced with smooth surfaces and without defects to allow for better pull through in conduits that are used to install such wires and cables. These materials need to have lubricity in order for them to be used in the manufacturing process, but in addition they need lubricity, for the pull through when the wires and cables are being installed.

Silicone materials have been typically used in such compositions for extrusion lubricity, by masticating together organic resins and certain silicone formulations containing siloxanes and optionally silicas to form the coating materials, after which, the compounded materials are completely cured through curing mechanisms associated with the functionality of the silicone materials. The compounded materials are used for a variety of end use applications wherein the silicone portions of the compounded materials lend lubricity in the manufacturing and installation process.

The structure of silicone materials is well known in the art. Silicone materials have wide bond angles, long bond lengths and relatively small atoms attached to silicon, allowing free rotation about the Si—O—Si backbone of such materials. (Chemistry and Technology of Silicone, W. Noll, Academic Press, New York and London, 1968).

This free rotation allows silicone materials, particularly polydimethylsiloxanes to be liquid over a very wide temperature range and at very high molecular weights. While the polymer appears very lubricious and in fact is, under low pressure situations, if the pressure increases between non-metal components, the silicone film between components gets thinner due to the silicone polymer altering its shape by rotation about the siloxane backbone.

Silicone materials are generally good lubricants for non-metal to metal or non-metal to non-metal systems. For example, pulling wire and cable through conduits is an example of plastic to metal or plastic to plastic lubrication. An example of lubricated cable can be found in U.S. Pat. No. 6,160,940, that issued on Dec. 12, 2000, that used organic lubricants as well as silicone lubricants to facilitate installation. Silicone gums could be the materials used as lubricants.

While silicone gums and fluids are good lubricants, if the pressure used during installation is high enough to push aside the siloxane, lubrication can be sub-optimal. Placing structure within siloxane materials is a method to increase the film thickness between moving materials. An example of increasing polymer structure to improve film thickness in metal to metal lubrication can be found in U.S. Pat. No. 4,577,523 to Eugene Groenhof, Column 4, lines 31 to 54.

Given the Groenhof information, the objective of the present invention was to increase film thickness by non-complete crosslinking of the siloxane component, yet allow easy manufacture and small droplet size of the siloxane lubricant within a thermoplastic carrier. It has been discovered that this allows easy manufacture of wire and cable coating having smooth surfaces (no loss of manufacturing lubrication), and it has also been discovered that this allows for enhanced pull through of the end product wire and cable through conduit.

It has now been found that enhanced pull through lubricity can be obtained and manufacturing lubricity that is, extrusion lubricity is maintained, by not completely curing the silicones. That is, by only curing the silicones partially, pull through lubricity is improved substantially without losing any of the lubricity that is required for manufacturing the wire and cable.

In the instant process, fire retardant materials are prepared providing a silicone, curable, fire retardant material and partially curing the silicone curable fire retardant material to a semi-fluid, gum-like gel.

For purposes of this invention, “semi-fluid, gum-like gel” means, in a more vulgar sense, a snotty, gel-like material.

“Partially curing” for purposes of this invention means any cure of the silicone component at less than “complete cure”. Preferred is a partial cure wherein a very small part of the normal curing agent is used, for example, less than or equal to 10 weight percent of the curing agent normally used for curing silicone materials. It was found that 1 weight percent of peroxide with the silicone base creates a fully cured system. Any amount less that amount partially cures. Most preferred is using less than 10 weight percent of the normal amount of curing agents used in these reactions.

As used herein as the prior art process for complete cure is the definition found in U.S. Pat. No. 6,759,487, and other such patents, i.e. “Mixing is continued until the melt viscosity (mixing torque) reaches a steady state value, thereby indicating that dynamic vulcanization of the diorganopolysiloxane of component (B) is complete. Alternatively, similar mixing procedures can be conducted continuously using an extrusion process, for example using a twin screw extruder.”

### THE INVENTION

Thus, there is provided in this invention a process for preparing fire retardant materials having enhanced pull through lubricity without loss of manufacturing lubricity, wherein the process comprises providing a silicone, curable, fire retardant material and partially curing the curable material to a semi-fluid, gum-like gel prior to any end use applications.

Also contemplated within the scope of this invention are the materials produced by such a process.

Another embodiment of this invention is a process for for preparing fire retardant materials having enhanced pull through lubricity wherein the process comprises providing a curable silicone system containing at least one fire retardant material, thereafter adding a catalyst to the curable silicone system for curing the silicone system, and thereafter, partially curing the curable system to a semi-fluid, gum-like gel.

The inventive processes can be used in any fire retardant system in which there is involved a curable silicone component.

For example, in a relative new process, invented by the inventors herein, and found in provisional patent application Ser. No. 61/395,997, filed on May 20, 2010, and incorporated herein by reference for what it teaches about the materials a processes therein, there is a one-step process for producing a compounded masterbatch for carrying fire retardant materials.

The process comprises combining concurrently the incipient materials a silicone polymer, optionally silica, and a carrier polymer selected from the group consisting essentially of thermoplastic polymers, thermoset prepolymers, rubber, thermoplastic prepolymers, oligomers of thermoplastic polymers, and, oligomers of thermoset polymers.

Thereafter, the incipient materials are masticated until the masticated material has a mean particle size of 100 microns or less. The ratio of the combined components silicone polymer and optionally silica to the carrier polymer is 0.5 to 99.5% to 99.5 to 0.5%.

There is a second embodiment that is the process as set forth above wherein, in addition, there is a fire retardant component added to the incipient materials prior to mastication.

Adjuvants can be added to the initial composition, that is, a silane, can be added to the incipient materials prior to mastication.

Yet, another adjuvant that can be added is a siloxane treating polymer that can be added to the incipient materials prior to mastication.

Still further, there can be added a combination of adjuvants, that is, a silane, and a siloxane treating polymer, can be added to the incipient materials prior to mastication.

Other curable silicone systems can be utilized in the process of this invention. These processes comprise a curable organopolysiloxane, optionally a crosslinking agent, and/or a curing agent to provide a curable silicone material.

Such curable silicone systems can be found in, and described in detail, in U.S. Patent Publication 2007/0108652 A1 that published on May 17, 2007.

This publication describes, at page 4, paragraphs [0025] through [0026], the various cure mechanisms and materials that can be used. It is therefore contemplated within the scope of this invention that peroxide cures, hydrosilyation and condensation cure mechanisms, are especially preferred. More specifically, there is disclosed in U.S. Pat. No. 6,465,552 that issued on Oct. 15, 2002, a radical cure for such systems. Both the publication and the patent are hereby incorporated by reference for what they teach about such curable silicone systems, including the preparation of particulate materials.

Further, Wacker Silicones manufactures and supplies a particulate silicone-based plastic additive known commercially as “Genioplast®” (a registered trademark owned by Wacker Silicones) which is contemplated as a curable silicone/organic polymer system useful in this invention. Also, similar products are available from Cri-Sil Technologies, Biddeford, Me. and General Electric Silicones.

Moreover, additional curable silicone systems that are also useful in this process are those found in U.S. Pat. Nos. 5,153,238; 3,824,208; 5,391,594; 5,288,674; 5,508,323; 5,916,952; 6,362,288; 6,417,293; 6,465,552;, 5,569,958; 6,649,704; 6,759,487, all of which are hereby incorporated by reference for what they teach about the preparation of such curable silicone systems.

### DETAILED DESCRIPTION OF THE INVENTION

The present invention therefore relates to a process for preparing fire retardant materials having enhanced pull through lubricity while maintaining manufacturing lubricity, wherein the process comprises providing a silicone, curable, fire retardant material and partially curing the curable fire retardant material to a semi-fluid, gum-like gel prior to any end use application having improved lubrication in higher pressure systems.

Carrier polymers useful in this invention include those selected from the group consisting essentially of thermoplastic polymers, thermoset prepolymers, rubber, thermoplastic prepolymers, oligomers of thermoplastic polymers, and, oligomers of thermoset polymers.

Thermosetting polymers and prepolymers, thermoplastic polymers and prepolymers, oligomers of thermoplastic and thermoset polymers, and rubbers of this invention are well known in the art and may be homopolymers or copolymers. As noted Supra, such materials may be thermoplastic or thermoset polymers, or rubbers and such materials can be for example polyphenylene ether, polystyrene, high impact polystyrene, polycarbonate, polypropylene, or the like. Examples of other thermoplastics are polysulfones, polyphenylene sulfide, acrylonitrile-butadiene-styrene copolymers, nylons, such as Nycoa (Nylon 6) available from Nycoa Nylon Corporation of America, Manchester, N.H., and Capron (Nylon 6), available from the BASF Corporation, Southfield, Mich., acetal, polyethylene and copolymers thereof, polyethylene terephthalate, polybutylene terephthalate, acrylics, fluoroplastics, and thermoplastic polyesters, among others.

Examples of thermosetting polymers which can be modified with the incipient materials of this invention include, for example, phenolics, epoxies, urethanes, unsaturated polyesters, polyimides, melamine formaldehyde, urea, and the like.

Preferred materials include, for example, Acrylonitrile butadiene styrene (ABS), polybutylene terephthalate (PBT), polyethylene terephthalate (PET), polypropylene (PP), polyethylene (PE), ethylene vinyl acetate 9EVA), thermoplastic polyurethane (TPU), styrene acrylonitrile (SAN), high impact polystyrene (HIPS), polyvinyl chloride (PVC), styrene ethylene butylene styrene (SEBS), ethylene propylene diene monomer (EPDM) rubber, natural rubber, nitrile rubber, nylon 5 (polyamide 5) and Nylon 66. Nylon 6 is available from Nycoa Nylon Corporation of America, Manchester, N.H., and Capron (Nylon 6), available from the BASF Corporation, Southfield, Mich.

The siloxane polymer of the incipient materials is a high consistency polymer. The polymer is preferred to have at least one type of functional group in the molecule, such a hydroxy, or vinyl, or the like.

Such siloxane polymers are preferred to have organic groups independently selected from hydrocarbon or halogenated hydrocarbon radicals such as alkyl and substituted alkyl radicals containing from 1 to 20 carbon atoms; alkenyl radicals, such as vinyl and 5-hexenyl; cycloalkyl radicals, such as cyclohexyl; and aromatic hydrocarbon radicals such as phenyl, benzyl or tolyl. Such materials are prepared by well-known methods, such as the acid or base catalyzed polymerization of cyclic diorganosiloxanes. Such materials are available from Bluestar Silicones USA Corporation, East Brunswick, N.J. and Rhodasil 759 from Rhodia.

The silica of the incipient materials is a finely divided filler derived from fume, precipitated or mined forms of silica. These silicas are typically characterized by surface areas greater than about 50 m²/gm. The fume form of silica is preferred to be a reinforcing filler based on the surface area, which can be as high as 900 m²/gm, but preferably has a surface area of 50 to 400 m²/gm.

For purposes of this invention, the silica can be, optionally treated with a silane, a siloxane treating polymer, or a combination of a silane and a siloxane treating polymer.

Such siloxane treating polymers can be, for example, low molecular weight liquid hydroxy- or alkoxy-terminated polydiorganosiloxanes, hexaorganodisiloxanes and hexaorganodisilazanes. The silicon bonded hydrocarbon radicals in all or a portion of these materials may contain substituents such as carbon-carbon double bonds, or the like.

As set forth Supra, the masticated incipient materials provide fire retardancy without the use of traditional fire retardants, but fire retardants can be used herein. It should be noted that the materials of this invention can be used without fire retardant synergists, such as antimony compounds, for example, antimony oxide which is well-known and used in most all halogen based fire retardant compositions.

Further, other significant improvements in properties of these inventive materials are: improved impact strength, tensile, elongation, Melt Flow Index, LOI, low smoke evolution, lower heat release rates, and lower carbon monoxide rates.

Still further, additional ingredients can be added to the compositions of the present invention. These additional ingredients include but are not limited to extending fillers such as quartz, calcium carbonate, and diatomaceous earths, pigments, electrically conducting fillers, heat stabilizers, fire retardants such as halogenated hydrocarbons, alumina trihydrate, magnesium hydroxide, organophosphorous compounds and other fire retardant materials.

The amounts of incipient materials are used such that the ratio of the combination of the siloxane polymer and the silica to the carrier polymer is 0.5 to 99.5 weight % to 99.5 to 0.5 weight %. Preferred for this invention are ratios of 85/30 to 15/70 and most preferred are ratios of 40/60 to 60/40.

The process of this invention is a one-step process whereby all of the incipient ingredients are added concurrently to a high intensity twin screw extruder to produce a masterbatch.

It is also contemplated within the scope of this invention to use other available equipment for manufacturing, such as Farrel Continuous Mixers, Buss Co-Kneaders, High mixing single screw extruders, two roll mills, Banbury mixers, paddle mixers, and the like.

The product from this process can be in emulsion form, solution form, or pellets or particles. It is preferred within the scope of this invention to provide particles having average sizes of 100 microns or less, and most preferred for this invention are particles having an average particle size of about 20 microns or less.

### EXAMPLES

Starting materials used in the following examples include Nycoa nylon, Capron nylon, 60,000 centistoke silicone polymer from Rhodasil 759 from Rhodia; gum/silica/peroxide blends FG 1348 and FG 1845; Gum FG 1613, from Cri-Sil Technologies. The sample were prepared on a W&P 255 twin screw extruder. The temperature profile and general purpose screw design were the same for all noted in Table I below.

TABLE I

| Screw Design | GP11 |
|---|---|
| Feed barrel location (Nylon 6 or Nylon 6 | 1 |
| plus an additive of this invention | |
| Feed barrel location Silicone blend | 5 |
| Temp. profile | |
| Zone 1 | 260 |
| Zone 2 | 250 |
| Zone 3 | 240 |
| Zone 4 | 280 |
| Zone 5 | 270 |
| Die | 250 |
| Rate (lbs/hr) | 20 |
| RPM range | |
| Low | 250 |
| High | 500 |

The following table II shows the results with several samples based on the Coefficient Of Friction testing. Run 10 was sampled to a customer. This run also includes a customer comment that the conduit pull through performance was 30 to 40% lower than prior art cable and wire.

The control sample is comprised of 1% Erucamide (Finawax E); 5% FG-1613 Silicone Fluid (No peroxide or silica); and 94% Allied 8202 nylon 6.

TABLE II

| Ingredient | Control film | 1 | 2 | 3 | 4 |
|---|---|---|---|---|---|
| Nycoa 1637-21439 | | | | | |
| (nylon 6) | | | | | |
| Capron 8202 | | 85.1 | 85.1 | 85.1 | 77.6 |
| (Nylon 6) | | | | | |
| Inv. Additive | | | | | 7.5 |
| Down stream | | | | | |
| addition | | | | | |
| 60 cst | | | | | |
| concentrate | | | | | |
| 25% downloaded | | | | | |
| downstream | | | | | |
| addition | | | | | |
| silicone blend | | 14.9 | 1.49 | 7.45 | 7.45 |
| (25% silica, | | | | | |
| 1% peroxide | | | | | |
| 75% vinylgum | | | | | |
| FG-1348) | | | | | |
| Silicone blend | | | | | |
| (3% silica, | | | | | |
| 1% peroxide | | | | | |
| 96% vinyl gum | | | | | |
| FG-1845) | | | | | |
| FG-1613 (to be | | | 13.41 | 7.45 | 7.45 |
| Blended in with | | | | | |
| Gum base) | | | | | |
| Totals | | 100% | 100% | 100% | 100% |
| Trial theme | gum and | (A) | (B) | (C) | (D) |
| | Erucamide* | | | | |
| Curl side in (B) | 0.115 | 0.145 | | 0.155 | 0.16 |
| Static coeff. | | | | | |
| Curl side in (B) | 0.02-0.10 | 0.06-0.14 | 0.03-0.13 | 0.02-0.08 | 0.05-0.15 |
| Kinetic Coeff. | | | | | |
| Ingredient | Control film | 5 | 6 | 7 | 8 |
| Nycoa 1637-21439 | | 77.6 | 77.6 | | |
| (nylon 6) | | | | | |
| Capron 8202 | | | | 70.1 | 85 |
| (Nylon 6) | | | | | |
| Additive | | 7.5 | 7.5 | | |
| Down stream | | | | | |
| addition | | | | | |
| 60 cst | | | | 15 | |
| concentrate | | | | | |
| 25% downloaded | | | | | |
| downstream | | | | | |
| addition | | | | | |
| silicone blend | | 14.9 | 7.45 | 14.9 | |
| (25% silica, | | | | | |
| 1% peroxide | | | | | |
| 75% vinylgum | | | | | |
| FG-1348) | | | | | |
| Silicone blend | | | | | 15 |
| (3% silica, | | | | | |
| 1% peroxide | | | | | |
| 96% vinyl gum | | | | | |
| FG-1845) | | | | | |
| FG-1613 to | | | 7.45 | | |
| be blended | | | | | |
| in with gum | | | | | |
| base | | | | | |
| Totals | | 100% | 100% | 100% | 100% |
| Trial theme | | (E) | (F) | (G) | (H) |
| Curl side in (B) | | 0.14 | 0.175 | 0.196 | 0.12 |
| Static coeff. | | | | | |
| Curl side in (B) | | 0.16-0.13 | 0.05-0.17 | 0.05-0.19 | 0.03-0.12 |
| Kinetic Coeff. | | | | | |

| Ingredient | Control film | 9 | 10 | 11 | 12 |
|---|---|---|---|---|---|
| Nycoa 1637-21439 | | | | | |
| (nylon 6) | | | | | |
| Capron 8202 | | 85 | 85 | 77.5 | 77.5 |
| (Nylon 6) | | | | | |
| Inv. Additive | | | | 7.5 | 7.5 |
| Down stream | | | | | |
| addition | | | | | |
| 60 cst | | | | | |
| concentrate | | | | | |
| 25% downloaded | | | | | |
| downstream | | | | | |
| addition | | | | | |
| silicone blend | | | | | |
| (25% silica, | | | | | |
| 1% peroxide | | | | | |
| 75% vinylgum | | | | | |
| FG-1348) | | | | | |
| Silicone blend | | 1.5 | 7.5 | 7.5 | 15 |
| (3% silica, | | | | | |
| 1% peroxide | | | | | |
| 96% vinyl gum | | | | | |
| FG-1845) | | | | | |
| FG-1613 (to be | | 13.5 | 7.5 | 7.5 | |
| Blended in with | | | | | |
| Gum base) | | | | | |
| Totals | | 100% | 100% | 100% | 100% |
| Trial theme | gum and | (I) | (J) | (K) | (L) |
| | Erucamide | | | | |
| Curl side in (B) | | | 0.115 | 0.14 | 0.125 |
| Static coeff. | | | | | |
| Curl side in (B) | | | 0.04-0.10 | 0.05-0.13 | 0.03-0.12 |
| Kinetic Coeff. | | | | | |

| Ingredient | Control film | 13 | 14 | 15 | 16 | 17 |
|---|---|---|---|---|---|---|
| Nycoa 1637-21439 | | | | | | |
| (nylon 6) | | | | | | |
| Capron 8202 | | 70 | 80 | 80 | 80 | 72.5 |
| (Nylon 6) | | | | | | |
| Inv. Additive | | | | | | 7.5 |
| Down stream | | | | | | |
| addition | | | | | | |
| 60 cst | | 15 | | | | |
| concentrate | | | | | | |
| 25% downloaded | | | | | | |
| downstream | | | | | | |
| addition | | | | | | |
| silicone blend | | | | | | |
| (25% silica, | | | | | | |
| 1% peroxide | | | | | | |
| 75% vinylgum | | | | | | |
| FG-1348) | | | | | | |
| Silicone blend | | 15 | 20 | 2 | 10 | 10 |
| (3% silica, | | | | | | |
| 1% peroxide | | | | | | |
| 96% vinyl gum | | | | | | |
| FG-1845) | | | | | | |
| FG-1613 (to be | | | | 18 | 10 | 10 |
| Blended in with | | | | | | |
| Gum base) | | | | | | |
| Totals | | 100% | 100% | 100% | 100% | 100% |
| Trial theme | gum and | (M) | (N) | (O) | (P) | (Q) |
| | Erucamide | | | | | |
| Curl side in (B) | | 0.125 | 0.125 | 0.152 | | 0.14 |
| Static coeff. | | | | | | |
| Curl side in (B) | | 0.04-0.11 | 0.03-0.13 | 0.05-0.15 | | 0.04-0.13 |
| Kinetic Coeff. | | | | | | |

(A) = 1.0% perox.(in base level) 25% silica, fully cured
(B) = 0.1% perox.: 2.5% silica
(C) = 0.5% perox.: 12.5% silica
(D) = 0.5% perox.12.5% orig. silica W/1950 downstream uncured 3.75% gum
*this material consists of 1% by weight of Erucamide (Finawax E), 5 weight % of FG-1613 silicone fluid containing no peroxide or silica and 94 weight % Allied 8202 Nylon 6.
(E) = Nycoa Nylon 1% perox., fully cured 25% orig. silica downstream uncured 3.75% gum
(F) = Nycoa Nylon 0.5% perox. 12.5% silica, downstream uncured 3.75% gum
(G) = 1% perox. Fully cured, 25% silica, 3.75% 60 cst silicone downstream
(H) = 1% perox, 0.3% silica
(I) = 0.1% perox.: 0.3% silica
(J) = 0.5% perox.: 1.5% silica; customer comment
(K) = 0.5% perox.: 1.5% original silica (uncured 3.75% gum down stream)
(L) = 1% perox., 3% silica, fully cured, 3.75% gum down stream
(M) = 1% perox., 3% orig silica, fully cured, 3.75% 60 cst silicone downstream
(N) = 1% perox. 3% silica base fully cured
(O) = 0.1% perox. 0.3% silica base
(P) = 0.5% perox. 1.5% silica base
(Q) = 0.5% perox., 1.5% original silica base, downstream, 3.75% gum addition

What is claimed is:

1. A process for preparing fire retardant materials having enhanced pull through lubricity, the process comprising:
A. providing a curable silicone system containing at least one fire retardant material and a catalyst for the curable silicone system;
B. partially curing the curable system to a semi-fluid, gum-like gel.

2. A process for preparing fire retardant materials having enhanced pull through lubricity, the process comprising:
A. providing a curable silicone system containing at least one fire retardant material and a catalyst for the curable silicone system, said silicone system being curable through a hydrosilyation reaction;
B. partially curing the curable fire retardant material to a semi-fluid, gum-like gel.

3. A process for preparing fire retardant materials having enhanced pull through lubricity, the process comprising:
A. providing a curable silicone system containing at least one fire retardant material and a catalyst for the curable silicone system, said silicone system being curable through a catalyzed silanol condensation reaction;
B. partially curing the curable fire retardant material to a semi-fluid, gum-like gel.

4. A process for preparing fire retardant materials having enhanced pull through lubricity, the process comprising:
B. providing a curable silicone system containing at least one fire retardant material and a catalyst for the curable silicone system, said silicone system being curable through free radical catalysis;
C. partially curing the curable fire retardant material to a semi-fluid, gum-like gel.

5. A process as claimed in claim 4 wherein the catalysis is provided by a peroxide.

6. A composition of matter when manufactured by the method as claimed in claim 1.

7. A composition of matter when manufactured by the method as claimed in claim 2.

8. A composition of matter when manufactured by the method as claimed in claim 3.

9. A composition of matter when manufactured by the method as claimed in claim 4.

10. A composition of matter when manufactured by the method of claim 5.

11. A process for preparing fire retardant materials having enhanced pull through lubricity, the process comprising:
A. providing a curable silicone system containing at least one fire retardant material;
C. thereafter adding a catalyst to the curable silicone system for curing the silicone system;
D. thereafter, partially curing the curable system to a semi-fluid, gum-like gel.
